(19) United States
(12) Patent Application Publication
(10) Pub. No.: US 2010/0218191 A1
(43) Pub. Date: Aug. 26, 2010

(54) Apparatus and Method for Processing Management Requests

(76) Inventor: Shivkumar KANNAN, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/420,064

(22) Filed: Apr. 8, 2009

(30) Foreign Application Priority Data
Feb. 24, 2009 (IN) 395/CHE/2009

(51) Int. Cl. G06F 9/46

(52) U.S. Cl. 718/103

(57) ABSTRACT

Embodiments of the present invention provide a method of processing a management request, comprising determining a priority level of the management request based upon one or more predetermined priority criteria. In some embodiments, the management requests are based on a Common Information Model (CIM) and control or monitor operation of an entity.

### RELATED APPLICATIONS

Benefit is claimed under 35 U.S.C. 119(a)-(d) to Foreign application Serial No. 395/CHE/2009 entitled “APPARATUS AND METHOD FOR PROCESSING MANAGEMENT REQUESTS” by Hewlett-Packard Development Company, L.P., filed on 24 Feb. 2009, which is herein incorporated in its entirety by reference for all purposes.

### BACKGROUND

Various management architectures have been defined for the management of entities and networks. Such management architectures are used for remotely managing entities such as servers, storage devices or systems, networks and processes or applications. FIG. 1 shows an example of a management system 100 comprising a management client 110 and a management server 120. A management client is a process which issues a management request 115. A management server 120 receives and processes the management request 115 and responds with a management response 116. For example, the management request 115 may request information regarding a status of a device instrumented by the management server 120, and the information is provided to the management client 110 in the management response 116.

Whilst FIG. 1 shows only a single management client 110, the management server 120 may receive management requests 115 from a plurality of management clients 110. Furthermore, some implementations of the management client 110 may issue multiple management requests 115 substantially simultaneously such that a number of management requests 115 are outstanding, that is awaiting management responses 116, at the same time. The management server 120 usually queues up received management requests 115 and executes them in received order. However, if the management server 120 receives a large number of management requests 115 in a short period of time, an appreciable delay may exist before the management server 120 issues corresponding management responses 116. This delay may be problematic for some management clients 110.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 shows an illustration of a management architecture;

FIG. 2 shows an illustration of a management architecture according to an embodiment of the present invention;

FIG. 3 shows an illustration of a plurality of queues included in a management server according to an embodiment of the invention;

FIG. 4 illustrates a method according to an embodiment of the invention;

FIG. 5 shows an illustration of a further management architecture according to an embodiment of the present invention;

FIG. 6 illustrates a management request according to an embodiment of the invention; and

FIG. 7 illustrates another method according to an embodiment of the invention.

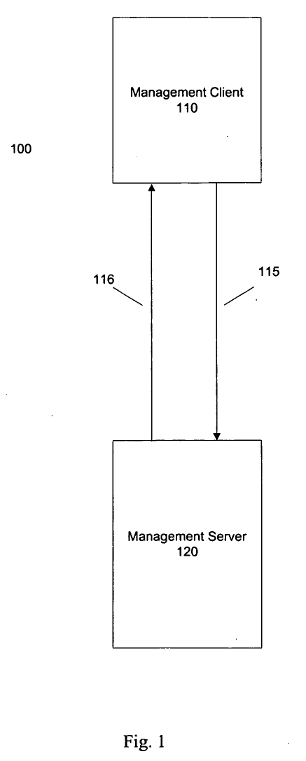

### DETAILED DESCRIPTION OF EMBODIMENTS OF THE INVENTION

A management architecture allows entities such as servers, storage devices or systems, networks, processes or applications to be monitored and controlled. Management architectures are defined by various standards. Examples of such standards are Common Information Model (CIM) and Web-Based Enterprise Management (WBEM) defined by The Distributed Management Task Force (DMTF). CIM is a conceptual model for describing a business' computing and networking environments. WBEM provides a coupling of CIM and Internet standard protocols and encodings such as XML and HTTP. Embodiments of the present invention will be described with reference to a WBEM architecture including a CIM server, “providers” of management data i.e. instrumentation, and one or more CIM clients. However, it will be realised that embodiments of the invention are not necessarily limited to WBEM and that embodiments of the present invention may be implemented according to any management architecture or standard.

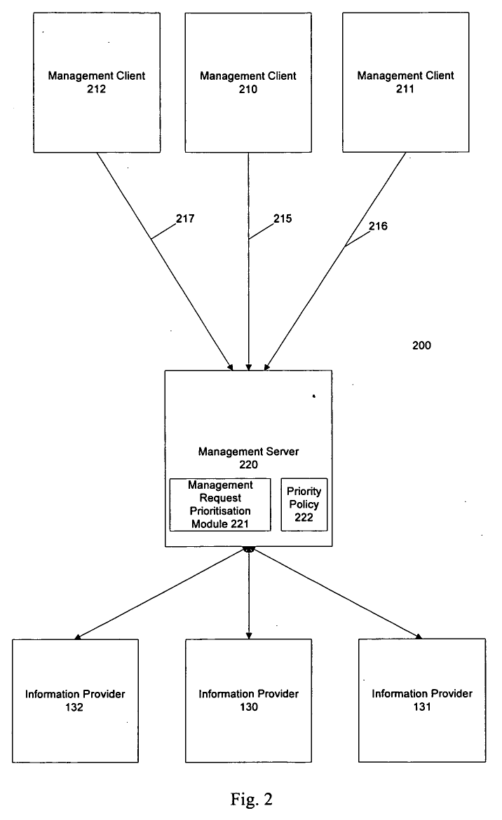

A management architecture 200 according to an embodiment of the present invention is shown in FIG. 2. The management architecture 200 comprises three management clients 210, 211, 212, although it will be realised that any number of management clients may be included in the management architecture 200. Each of the management clients 210, 211, 212 operatively issues management requests 215, 216, 217 to a management server 220. Whilst one management server 220 is shown, the architecture 200 may comprise more than one management server 220. The management server 220 acts to communicate management information from one or more providers 130, 131, 132 which, for example, instrument hardware, according to the received management requests 215, 216, 217. In the architecture 200 shown in FIG. 2, the management server 220 is communicatively coupled to three information providers 130, 131, 132, although this is merely exemplary.

The management server 220 comprises a management request prioritisation module (MRPM) 221. The MRPM 221 assigns a priority to received management requests 215, 216, 217. In some embodiments, the MRPM 221 assigns a priority to each management request 215, 216, 217 according to information contained in the respective management request 215, 216, 217, including information contained within a header of the management request 215, 216, 217. In another embodiment, the MRPM 221 assigns a priority to each management request 215, 216, 217 based upon the origin of the management request 215, 216, 217. Advantageously these embodiments do not require modification of a management standard to which the management requests 215, 216, 217 conform.

The management server 220 processes management requests 215, 216, 217 based upon the assigned priorities. In the described embodiments of the present invention, three priority levels are utilised: high, medium and low. However, it will be realised that any number of priority levels may be used. For example, numerical priority levels may be assigned of between 1 (highest priority) and 5 (lowest priority), or of between 1 and 10.

As noted above, in some embodiments the MRPM 221 assigns a priority to each received management request 215, 216, 217 based upon the content of the management request 215, 216, 217. In one embodiment, the MRPM 221 assigns a priority to each management request 215, 216, 217 based upon an operation name contained in the management request 215, 216, 217. In another embodiment, the MRPM 221 assignments a priority to each management request 215, 216, 217 based upon the operation name and operation content specified in relation to the operation name. Examples of CIM operation names include GetInstance, EnumerateInstances, AssociatorNames, GetClass or the name of an extrinsic method defined to extend the CIM schema. Other operations are defined by the DMTF in Specifications for CIM Operations over HTTP available from www.dmtf.org, which is herein incorporated by reference. Examples of operation content include a ClassName or an InstanceID provided as a parameter to the operation. For example, operation content may be: ClassName=HPEVA_consistencyset, InstanceID=ABC0001.

The operation name and the operation content may be obtained from the management request 215, 216, 217 either by examination of a header of the management request 215, 216, 217, or by parsing the management request 215, 216, 217. If parsing is required, it may be performed on the management request 215, 216, 217 either by the management server 220 or by the MRPM 221.

In another embodiment, the MRPM 221 is arranged to assign a priority to each management request 215, 216, 217 based upon the origin of that management request 215, 216, 217. For example, management requests 215, 216, 217 originating from one or more predetermined clients may be assigned a high priority, whereas management requests originating from other clients may be assigned a lower priority. Identification of the origin of the management requests 215, 216, 217 may be performed on the basis of a network address, e.g. an IP address, identified in connection with the management request 215, 216, 217.

The MRPM 221 is arranged to assign the priority to the management requests 215, 216, 217 on the basis of a priority policy 222. The priority policy 222 may be defined by an application developer or by an administrator of the management server 220. The priority policy 222 is stored in a storage device accessible by the management server 220. A default priority may be specified in the priority policy 222 which is applied by default to all management requests 215, 216, 217 unless the management request 215, 216, 217 meets criteria defined in the priority policy 222. In one embodiment, the default priority is defined in the priority policy 222 as medium. The priority policy 222 may use any convenient system for defining the criteria against which the management requests 215, 216, 217 are assessed. For example, the priority policy 222 may use a system of Boolean expressions. In some embodiments, the priority policy 222 defines one or more operations or origins of management requests 215, 216, 217 which are to be assigned a different priority from the default priority, for example a higher or lower priority. The priority policy 222 may use relational operators, such as “=”, “>”, “<”, and Boolean operators such as AND and OR.

For example, in the embodiment of the invention in which priorities are assigned to management requests 215, 216, 217 on the basis of the operation name only, the priority policy 222 may define:
High Priority
OperationName=EnumerateInstanceNames OR OperationName=GetInstance
Low Priority
OperationName=InvokeMethod

Whereas in embodiments of the invention in which priorities are assigned to management requests 215, 216, 217 on the basis of the operation name and the operation content, the priority policy 222 may define:
High Priority
1) OperationName=EnumerateInstanceNames AND ClassName=HPEVA_consistencyset
2) OperationName=GetInstance AND ClassName=HPEVA_consistencyset AND InstanceID=ABC0001
3) OperationName=InvokeMethod AND ClassName=HPEVA_ReplicationService AND MethodName=failover
Low Priority
OperationName=InvokeMethod AND ClassName=cim_storageconfigurationservice AND MethodName=createvolume

In embodiments in which network addresses are mapped to priority levels, the priority policy 222 may define:
High Priority
IP Address=208.77.188.166 OR IP Address=208.77.188.168
Low Priority
IP Address=172.16.254.1

Mapping of the operation name to the priority of each management request 215, 216, 217 allows fast servicing of management requests 215, 216, 217. However, the mapping of operation names and operation content to priorities allows fine-grained control over the priority of each management request 215, 216, 217. Mapping of the origin of management requests 215, 216, 217 to priorities may be combined with either of the content-based embodiments. For example, management requests 215, 216, 217 having a particular origin may be given a high priority, whereas all other management requests may be prioritised based upon their content.

Following prioritisation by the MRPM 221, the management server 220 processes the management requests 215, 216, 217 based, at least in part, on the assigned priority of each request 215, 216, 217.

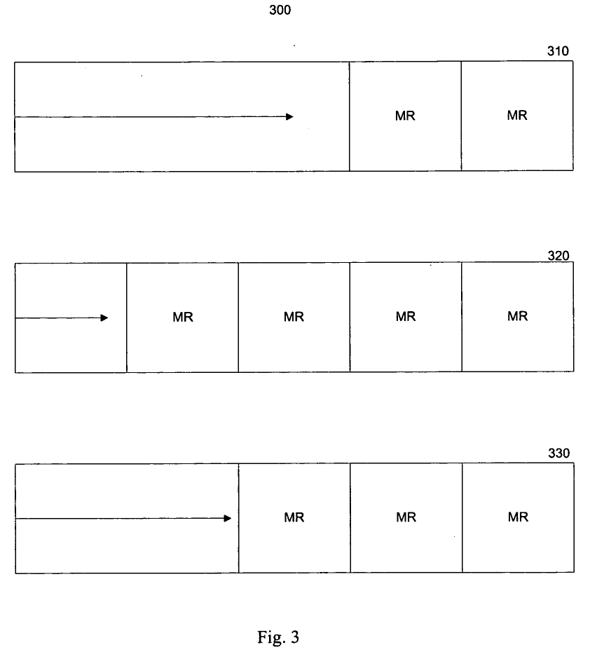

In one embodiment, the management server 220 comprises a queue for each priority level assigned by the MRPM 221. FIG. 3 shows an illustration of a queue architecture 300 comprising three queues 310, 320, 330 in the management server 220 supporting low, medium and high priority levels respectively. A first queue 310 is used to store management requests prioritised as high priority. A second queue 320 is used to store management requests prioritised as medium priority and a third queue 330 is used to store management requests prioritised as low priority. In embodiments of the management server 220 supporting other numbers of priority levels, the number of queues 310, 320, 330 is changed accordingly. The queues 310, 320, 330 are operated as FIFO buffers to hold prioritised management requests before processing by the management server 220. The use of queues 310, 320, 330 to hold prioritised management requests is advantageous in that the management server 220 does not have to re-order received management requests or keep track of received requests. As such, the processing of management requests is stateless. Management requests 215, 216, 217 prioritised by the MRPM 221 are placed into a tail of an appropriate one of the queues 310, 320, 330. The management server 220 then sequentially removes management requests from a head of each queue 310, 320, 330 and processes them in a normal way.

In order to avoid starvation of lower-priority management requests, embodiments of the management server 220 implement a weighted algorithm to ensure that lower-priority management requests are processed even in the presence of higher-priority management requests. For example, a weighted round robin (WRR) scheduling discipline may be employed to ensure processing of lower-priority management requests.

In another embodiment, the management server 220 employs concurrent thread-based processing of management requests 215, 216, 217. The management server 220 spawns a new thread to service each management request 215, 216, 217. A priority of each thread is determined according to the priority of the management request, as determined by the MRPM 221, which it will service. In this way, higher-priority management requests 215, 216, 217 are processed by the management server 220 with a higher-priority thread, for example scheduled to have an increased processing time, than lower-priority requests. However, a weighted algorithm such as WRR may be employed to avoid starvation of lower-priority management requests 215, 216, 217.

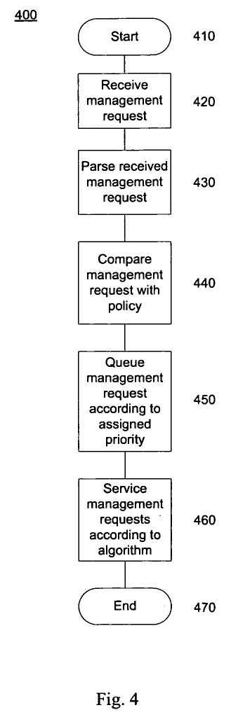

FIG. 4 illustrates a method 400 according to an embodiment of the invention. The method 400 begins in step 410. In step 420 a management request 215, 216, 217 is received by the management server 220. In step 430, the received management request 215, 216, 217 is parsed to determine either an operation name or an operation name and operation content of the management request 215, 216, 217. In step 440, the management request is prioritised, or assigned a priority level, by comparing the content of the management request 215, 216, 217 with a priority level supported by the management server 220 according to the priority policy 222. As discussed above, the prioritisation may be performed on the basis of the operation specified in the management request, the operation and the operation content, or the origin of the management request 215, 216, 217. In step 450, the prioritised management request is queued according to its priority. In an alternative embodiment, a thread may be invoked in step 450 to service the management request, the thread having a priority level based upon the priority level of the management request 215, 216, 217. In step 460, management requests are processed according to their priority levels. It will be realised that step 460 will, in some embodiments, be performed simultaneously with the other steps shown in FIG. 4. That is, management requests 215, 216, 217 may be processed whilst other management requests 215, 216, 217 are received and prioritised by the management server 220. The method ends in step 470.

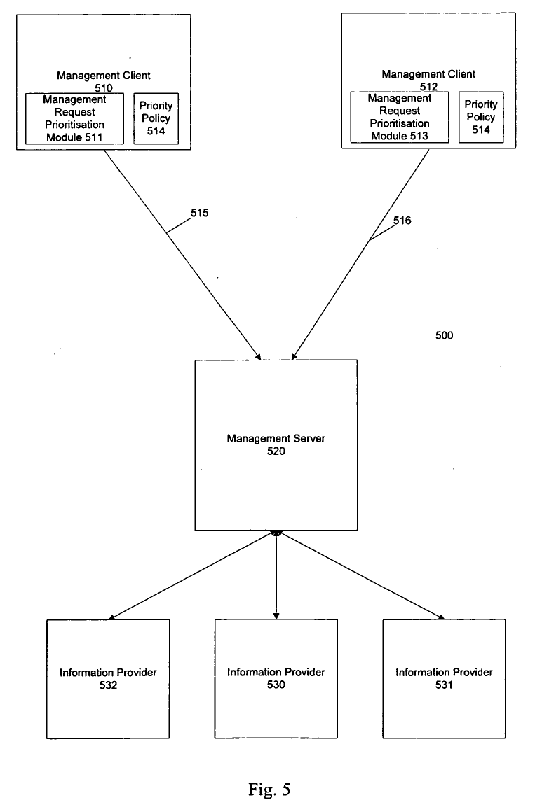

Further embodiments of the invention will now be described with reference to FIGS. 5 to 7.

FIG. 5 illustrates a management architecture 500 comprising first and second management clients 510, 512, a management server 520 and three information providers 530, 531, 532. Whilst the example architecture 500 is shown comprising two management clients 510, 512 and three providers 530, 531, 532, these are merely exemplary numbers. In the embodiments described with reference to FIGS. 5 to 7, prioritisation of management requests 515, 516 is performed at a management client 510, 512. Each management request 515, 516 includes priority information indicating the priority given to the management request 515, 516 by the management client 510, 512. The management requests 515, 516 are processed by the management server 520 according to the priority information contained therein.

As shown in FIG. 5, the management clients 510, 512 each comprise a management request prioritisation module (MRPM) 511, 513 and a priority policy 514. The priority policy 514 included in the management clients 510, 512 are labelled with the same reference numeral to indicate that the management clients 510, 512 prioritise management requests based upon the same priority policy 514. Thus, the management server 520 receives uniformly prioritised management requests 515, 516. However, the management clients 510, 512 may alternatively each operate according to different priority policies 514.

One embodiment of the MRPM 511, 513 will now be described. In this embodiment, management requests 515, 516 are prioritised according to a process or application on the management client 510, 512 which issues the management request 515, 516. For example, management requests 515, 516 originating from a particular process may be prioritised as high priority, whereas management requests 515, 516 originating from another process may be prioritised as low priority and all other management requests prioritised as medium priority.

In other embodiments, the MRPM 511, 513 and priority policy 514 included in the management clients 510, 512 prioritise management requests based upon either an operation or an operation and operation content, as described previously with reference to the MRPM 221 and priority policy 222. Advantageously, by assigning a priority to each management request 515, 516 at the management clients 510, 512 processing at the management server 520 is reduced since each management client 510, 512 only prioritises management requests 515, 516 originating from that client 510, 512.

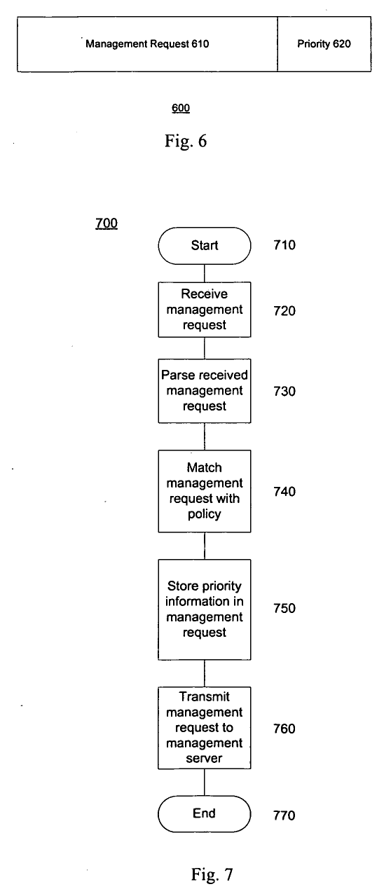

FIG. 6 shows an illustration of a management request 600 according to embodiments of the invention in which the management client 510, 512 prioritises the management requests 515, 516. The management request 600 comprises management request information 610 specifying an operation and associated operation content and priority information 620 which indicates the priority given to the management request by the management client 510, 512. The management request 600 may comprise further information and the ordering or location of the management request information 610 and priority information 620 may differ from that shown.

FIG. 7 illustrates a method 700 according to an embodiment of the invention of prioritising management requests by the MRPM 511, 513. The method begins in step 710 and in step 720 a management request 515, 516 is received by the MRPM 511, 513 from a process. In step 730 the management request 515, 516 is parsed to determine either an operation or an operation and operation content of the management request. Alternatively, in step 730 the MRPM 511, 513 may determine a process from which the management request 515, 516 originated. In step 740 the determined information is compared against the priority policy 514. In step 750 priority information is stored in the management request 515, 516 to convey an indication of the assigned priority to the management server 520. In step 760 the management request 515, 516 is communicated to the management server 520 and the method ends in step 770.

Once a management request 515, 516 containing priority information 620 is received by the management server 520, it is processed based upon the priority information contained therein. As described previously, the management server 520 may comprise a plurality of queues 310, 320, 330, into one of which each management request 515, 516 is placed according to the priority information 620. Alternatively, the management server 520 may spawn a new management request processing thread to process each received management request 515, 516, wherein a priority of each thread is determined according to the priority information 620. In either implementation, a weighted algorithm, such as WRR may be used to avoid starvation of lower-priority management requests at the management server 520.

Embodiments of the present invention allow management requests to be processed according to one or more priority criteria. Advantageously, the priority criteria allow management requests which require a relatively rapid response to be assigned a higher priority than other management requests which may be serviced in a relatively longer period of time. Embodiments of the present invention may be implemented as CIM-based clients and servers, such as WBEM. Alternatively, embodiments of the present invention may be implemented according to other management specifications, such as Directory Enabled Networks (DEN).

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of processing a management request, comprising:
determining a priority level of the management request based upon one or more predetermined priority criteria.

2. The method of claim 1, wherein the priority criteria determine the priority level of the management request based, at least in part, on information in the management request or a header of the management request.

3. The method of claim 2, wherein the priority criteria determine the priority level of the management request based, at least in part, on an operation identified in the management request and/or content of the operation identified in the management request.

4. The method of claim 1, wherein the priority criteria determine the priority level of the management request based, at least in part, on information identifying an origin of the management request.

5. The method of claim 4, wherein the origin of the management request identifies a network address of a management client having issued the management request.

6. The method of claim 4, wherein the origin of the management request identifies a process having issued the management request.

7. The method of claim 1, comprising servicing the management request according to the determined priority level.

8. The method of claim 7, wherein servicing the management request comprises one of allocating the management request to one of a plurality of queues according to the priority level, or spawning a thread to service the management request, wherein a priority of the thread is determined according to the priority level of the management request.

9. An apparatus for processing management requests, comprising:
means to determine a priority level of a received management request based upon one or more predetermined priority criteria.

10. The apparatus according to claim 9, wherein the means to determine the priority level is arranged to determine the priority level of the management request based, at least in part, on information in the management request or a header of the management request according to the priority criteria.

11. The apparatus according to claim 10, wherein the means to determine the priority level of the management request is arranged to determine the priority level of the management request based, at least in part, on an operation identified in the management request and/or content of the operation identified in the management request.

12. The apparatus according to claim 9, comprising means to determine an origin of the management request, wherein the means to determine the priority level of the management request is arranged to determine the priority level of the management request based, at least in part, on the origin of the management request.

13. An apparatus for processing a Common Information Model (CIM) based management request, comprising:
a store containing information indicating one or more priority criteria;
a management request processor for processing management requests and assigning one of a plurality of priority levels to each management request based upon the priority criteria.

14. The apparatus according to claim 13, wherein the priority criteria define a priority level of the management request based, at least in part, on information in the management request or a header of the management request according to the priority criteria.

15. The apparatus according to claim 13, wherein the apparatus is a management client and comprises a means to store information indicating the assigned priority level in the management request.
